(19) United States
(12) Patent Application Publication
(10) Pub. No.: US 2014/0184411 A1
(43) Pub. Date: Jul. 3, 2014

(54) ALARM CONDITION PROCESSING IN NETWORK ELEMENT

(71) Applicant: Alcatel Lucent, Paris (FR)

(72) Inventor: Alec Brusilovsky, Naperville, IL (US)

(73) Assignee: Alcatel Lucent, Paris (FR)

(21) Appl. No.: 13/731,280

(22) Filed: Dec. 31, 2012

(51) Int. Cl. G08B 21/18

(52) U.S. Cl. CPC G08B 21/18
USPC 340/541

(57) ABSTRACT

Techniques for alarm condition processing in communication networks. In one example, a method comprises the following steps. An alarm condition associated with a network element of a communication network is detected. Alarm indication data is generated based on the alarm condition detected. The alarm indication data is protected using a cryptographic key to generate protected alarm indication data. The protected alarm indication data (e.g., tamper evidence) is stored in a non-volatile memory, and may be reset either autonomously (e.g., timer expiration) or from the communication network.

### FIELD

The field relates generally to communication networks, and more particularly to alarm condition processing in such communication networks.

### BACKGROUND

With the proliferation of distributed communication networks wherein network elements are distributed over a large geographic area, protection of the network elements from tampering and intrusion is important to owners of the data stored on or passing through such network elements.

One approach is to incorporate an intrusion alarm mechanism in a network element whereby the alarm is triggered when the physical housing (e.g., case, crate, equipment rack, etc.) of the network element is opened or otherwise compromised. However, when external power to the housing is cut by a person or system seeking to tamper with the network element and its data (i.e., intruder), the intrusion alarm will not be activated. Simple contact alarms (e.g., door switches) have also been offered in network elements but are largely ineffective in deterring intruders.

Further, simple tamper-evident mechanisms including color-changing tamper-evident tapes or seals are known to be used on network elements. However, these implementations are not flexible and do not allow resets without attending to the device, e.g., re-applying the tape or the seal.

Another approach includes the secure electronic retention of alarm condition data in a tamper-resistant environment so as to prevent an intruder from clearing any alarm condition indications by simply deleting the alarm condition data. The tamper-resistant environment is implemented in hardware but is limited in terms of its storage capacity as well as its complexity/price.

### SUMMARY

Embodiments of the invention provide techniques for alarm condition processing in communication networks.

In one embodiment, a method comprises the following steps. An alarm condition associated with a network element of a communication network is detected. Alarm indication data is generated based on the alarm condition detected. The alarm indication data is protected using a cryptographic key to generate protected alarm indication data. The protected alarm indication data is stored in a non-volatile memory.

Advantageously, illustrative embodiments of the invention provide cryptographic techniques for preserving alarm condition data in a tamper-evident and resettable manner so as to prevent intruders from tampering with network elements in a communication network.

These and other features and advantages of the present invention will become more apparent from the accompanying drawings and the following detailed description.

### BRIEF DESCRIPTION OF THE DRAWINGS

FIG. 1 illustrates a network element with tamper-evident and resettable processing of alarm conditions according to an embodiment of the invention.

FIG. 2 illustrates a methodology for tamper-evident and resettable processing of alarm conditions according to an embodiment of the invention.

FIG. 3 illustrates a communication network with network elements suitable for implementing tamper-evident and resettable processing of alarm conditions according to an embodiment of the invention.

### DETAILED DESCRIPTION

Embodiments of the invention will be described herein in the context of illustrative architectures associated with network elements and communication networks. However, it is to be understood that embodiments of the invention are not limited to the illustrative network element and communication network architectures shown. Rather, embodiments of the invention are more generally applicable to any network element and communication network in which it would be desirable to provide techniques for processing and securely storing alarm conditions.

As used herein, the phrase “network element” refers to any computing device associated with a communication network. By way of example only, such computing device may be a router, a switch, a base station, a mobile terminal, etc. Embodiments of the invention are not limited to any particular type of network element.

As will be illustratively explained herein, embodiments of the invention provide cryptographic methods to store alarm indication data of a network element in a tamper-evident and resettable manner. In one or more embodiments, alarm indication data may comprise one or more of alarm condition indicators, alarm metadata, and auxiliary data associated with an alarm condition.

As used herein, the phase “alarm condition indicator” refers to a record of a certain alarm condition, for example, a binary value indicative of whether a case of a given network element has been opened (e.g., one of a logic “1” or logic “0”) or has remained closed (e.g., the other of a logic “1” or logic “0”) over a given time period.

Further, as used herein, the phrase “alarm metadata” refers to a set of data stored in addition to the alarm condition indicator. For example, the alarm metadata may comprise a voltage reading or temperature reading corresponding to a certain alarm condition.

Still further, as used herein, the phrase “auxiliary data” refers to set of data corresponding to one or more recorded alarm conditions, for example, photographs, sound or video recordings which are taken prior, during or directly after the alarm condition.

As mentioned above, existing methods to ensure the secure retention of alarm condition indicators, alarm metadata, and the auxiliary data associated with an alarm condition include recording these data elements in a tamper resistant environment (TRE). However, it is realized that the TRE is implemented in hardware and is limiting from the point of view of its storage capacity as well as its complexity/price.

It is currently known how to protect data during its transmission over an insecure channel, where eavesdropping, unauthorized data manipulation (change and injection), and replay can happen. However, existing storage approaches do not known how to adequately protect data from similar eavesdropping, unauthorized manipulation (change and injection), and replay which can happen during the storage of the data in an insecure environment.

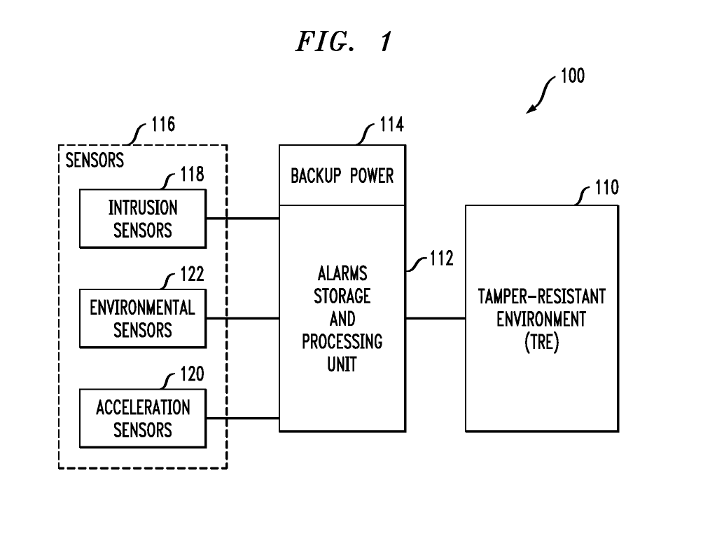

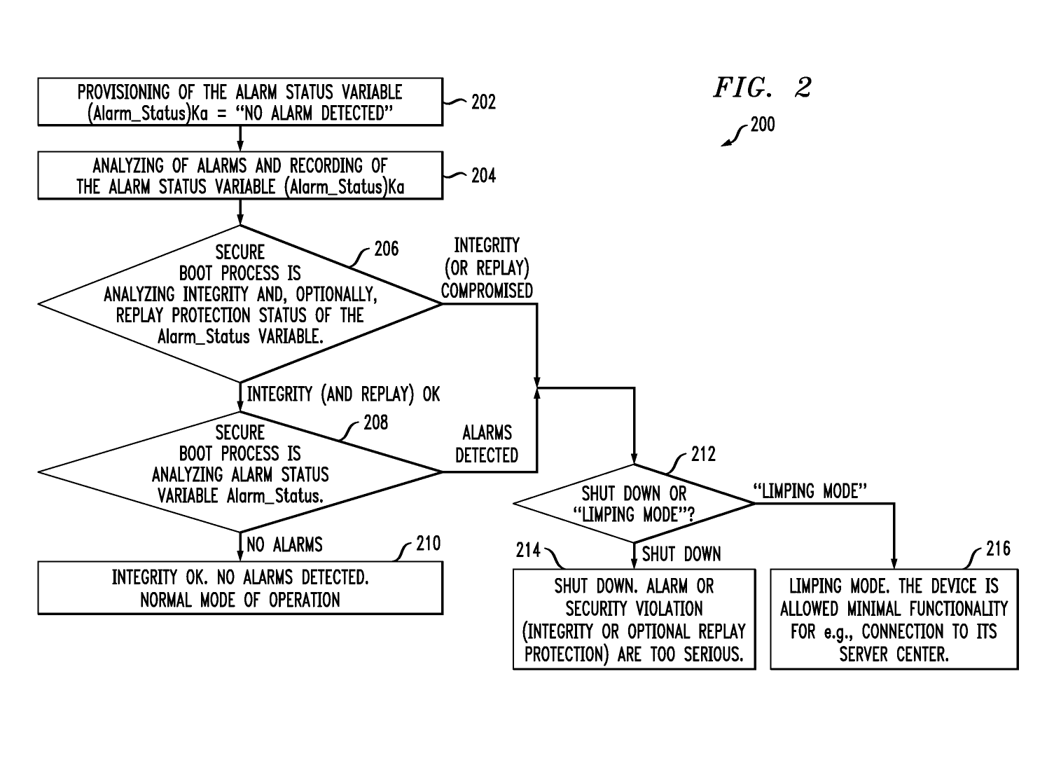

Embodiments of the invention address these and other issues associated with the secure storage of alarm indication data in network elements. In one embodiment, the secure storage of alarm indication data can be characterized as a delayed transmission (e.g., store and forward) of that alarm indication data to the same entity which generated the alarm indication data. While it is important to preserve the alarm condition data and protect it from tampering (tamper resistance), such environment may prove to be rather expensive. It is thus realized that a suitable approach that balances cost and complexity with security would be to create a tamper-evident environment. FIGS. 1 and 2 illustrate a system and methodology for providing such a tamper-evident environment.

FIG. 1 illustrates a network element with tamper-evident and resettable processing of alarm conditions according to an embodiment of the invention. As shown, network element 100 comprises a tamper-resistant environment 110, an alarm storage and processing unit 112, a backup power source 114, and a set of alarm sensors 116 comprising intrusion sensors 118, acceleration sensors 120 and environmental sensors 122. It is to be understood that the network element 100 may comprise other types of alarm sensors not expressly shown.

Examples of intrusion sensors 118 include, but are not limited to, one or more of physical intrusion detectors (e.g., door switches, other activation switches, etc.) and electronic intrusion detectors (e.g., software that detects network hacking activities, etc.). Examples of acceleration sensors 120 include, but are not limited to, detectors that sense and/or record movement of the network element 100. Examples of environmental sensors 122 include, but are not limited to, sensors operable to measure voltage levels and/or temperature levels within the network element 100 in order to aid in the analysis of an alarm condition.

In general, the set of alarm sensors 116 generate alarm indication data when an alarm condition is detected by one or more of the sensors that comprise the set. The generated alarm indication data is provided to the alarm storage and processing unit 112 for processing and storage in accordance with embodiments of the invention. FIG. 2 shows one embodiment for processing and storing such data that can be implemented in the unit 112.

The alarm storage and processing unit 112 is operable to store alarm indication data in non-volatile memory. The non-volatile memory may comprise actual non-volatile memory (NVM), for example, flash memory or EEPROM, or may comprise RAM utilizing a backup battery. The backup power source 114 in network element 100 ensures that the data stored in unit 112 is preserved even if power is cut to the network element (i.e., acts as nonvolatile memory).

Network element 100 also comprises tamper-resistant environment (TRE) 110 which is operable to store a cryptographic key (secure alarm key) and store secure boot procedures for the network element 100, as will be explained below in the context of FIG. 2. The TRE 110 can be smaller in storage capacity and thus less costly than what is otherwise needed by conventional network elements that utilize a tamper-resistant environment to attempt to secure alarm condition data.

FIG. 2 illustrates a methodology for tamper-evident and resettable processing of alarm conditions according to an embodiment of the invention. As shown in methodology 200, provisioning of an alarm condition indicator occurs in step 202. By default, when the network element 100 is powered up for the first time, the alarm condition indicator (variable Alarm_Status in this example, although other alarm indication data could be provisioned here as well including, but not limited to, alarm metadata and auxiliary data as mentioned above) is populated with a logic “0” value indicating “no alarm detected.” Note the choice of logic “0” rather than logic “1” to represent that no alarm is detected is arbitrary.

Before storage of this alarm condition indicator in unit 112, the value is integrity protected in unit 112 by encrypting the value using a secret cryptographic key Ka to generate protected value (Alarm_Status)Ka. The key is stored in TRE 110. The alarm condition indicator value may also be replay protected and/or confidentiality protected before being stored in unit 112.

In step 204, upon triggering of an alarm condition (i.e., an alarm condition is detected by one or more of the set of sensors 116), for example, a case intrusion, the alarm storage and processing unit 12 (possibly now being powered by the backup power source 114 depending on the alarm condition type) receives the alarm indication data from the set of sensors 116. This means that the unit 112 receives the Alarm_Status value set to logic “1” indicating an alarm has been detected. The unit 112 then integrity protects the value using secret cryptographic key Ka, as explained above, to generate protected value (Alarm_Status)Ka. Again, the alarm condition indicator value may also be replay protected and/or confidentiality protected before being stored in unit 112. Thus, the unit 112 processes any alarm indication data it receives and stores it in non-volatile memory.

In step 206, at a subsequent power up cycle of the network element 100, the network element goes through a secure boot-up validation procedure (secure boot process), during which the stored protected alarm indication data is analyzed for integrity attacks, and possibly for replay and confidentiality attacks if such protection was implemented. This may include decrypting the data using the secret cryptographic key Ka (which as mentioned above is stored in TRE 110).

More specifically, in one embodiment, the secure boot process analyzes an integrity (and possibly replay and/or confidentiality, if instituted) protection status of the Alarm_Status variable. For example, the alarm condition indicator value being analyzed is compared against a securely stored (e.g., in TRE 110) reference alarm condition indicator value. If these two values are the same, upon successful check, then it is assumed that there was no tampering with the data. However, if the values are different, then the network element assumes that the data has been tampered with. Note that if the reference value remains constant, the attacker can substitute (replay) the alarm condition indicator value with the expected (constant) value. To protect against such a replay attack, the expected reference value may be changed at every successful check or reset (e.g., by adding freshness based on time, etc. to the reference value and alarm condition indicator value computations).

If any security breach of the alarm indication data due to tampering is evident (integrity or replay/confidentiality protection is compromised, as explained above), the methodology moves from step 206 to step 212. In step 212, the network element 100 decides whether to: (1) enable a limping mode (step 216), wherein the device is allowed minimal functionality, for example, connection to its service center; or (2) if the alarm or security violation is too serious, shut down the network element (step 214).

If the security of the stored alarms has not been compromised in step 206, that is, the integrity and replay/confidentiality status are considered fine (ok), the secure boot process, in step 208, analyzes the alarm status variable Alarm_Status, i.e., monitors current alarm conditions. If an alarm condition is detected, the methodology goes back to step 212 and makes the shut down (step 214) or limping mode (step 216) decision. If, however, no new alarm condition is detected, then the network element 100 proceeds to normal operation (dependent on what the function of the network element is, e.g., routing, switching, etc.).

Accordingly, it is to be understood that the ability of methodology 200 to detect an alarm condition is its tamper-evident property. After the methodology 200 goes into the shut down (step 214) or limping mode (step 216), the network element or user can contact the communication network in which it is deployed or its operator to either report or clear (reset) the detected alarm condition. Alternatively, the detected alarm condition may be reset based on a timer or any other programmable event.

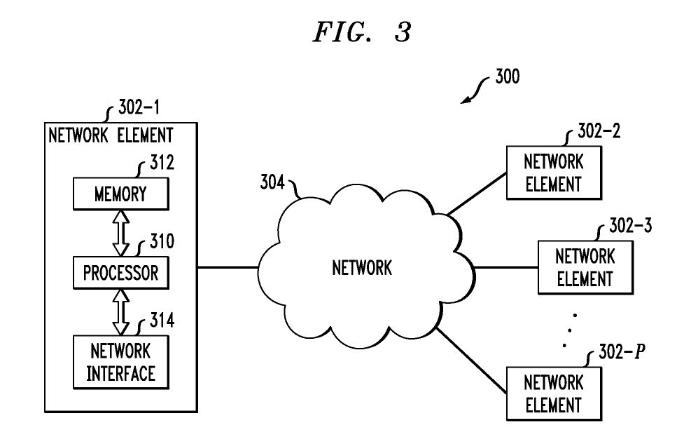

Lastly, FIG. 3 illustrates a communication network with network elements suitable for implementing tamper-evident and resettable processing of alarm conditions according to an embodiment of the invention.

As shown in network 300, computing devices 302-1, 302-2, 302-3, . . . , 302-P are operatively coupled via communication network media 304. The network media can include any network media across which the computing devices are capable of communicating including, for example, a wireless medium and/or a wired medium. By way of example, the network media can carry IP (Internet Protocol) packets end to end (from one computing device to another). However, embodiments of the invention are not limited to any particular type of network medium.

It is to be understood that one or more of the computing devices 302 shown in FIG. 3 represent a network element 100 as described above in the context of FIGS. 1 and 2.

As would be readily apparent to one of ordinary skill in the art, the computing devices in FIG. 3 may be implemented as programmed computers operating under control of computer program code. The computer program code would be stored in a computer (or processor) readable storage medium (e.g., a memory) and the code would be executed by a processor of the computer. Given the description herein, one skilled in the art could readily produce appropriate computer program code in order to implement the methodologies and protocols described herein.

Nonetheless, FIG. 3 generally illustrates an exemplary architecture for each computing device communicating over the network media. As shown, computing device 302-1 comprises processor 310, memory 312, and network interface 314. Thus, each computing device in FIG. 3 may have the same or a similar computing architecture.

It should be understood that the term “processor” as used herein is intended to include one or more processing devices, including a signal processor, a microprocessor, a microcontroller, an application-specific integrated circuit (ASIC), a field programmable gate array (FPGA) or other type of processing circuitry, as well as portions or combinations of such circuitry elements. Also, the term “memory” as used herein is intended to include electronic memory associated with a processor, such as random access memory (RAM), read-only memory (ROM), non-volatile memory (NVM), or other types of memory, in any combination. Further, the phrase “network interface” as used herein is intended to include any circuitry or devices used to interface the computing device with the network and other network components. Such circuitry may comprise conventional transceivers of a type well known in the art.

Accordingly, software instructions or code for performing the methodologies and protocols described herein may be stored in one or more of the associated memory devices, e.g., ROM, fixed or removable memory, and, when ready to be utilized, loaded into RAM and executed by the processor. That is, each computing device shown in FIG. 3 may be individually programmed to perform steps of the methodologies and protocols depicted in FIGS. 1 and 2.

Although illustrative embodiments of the invention have been described herein with reference to the accompanying drawings, it is to be understood that embodiments of the invention are not limited to those precise embodiments, and that various other changes and modifications may be made by one skilled in the art without departing from the scope or spirit of the invention.

What is claimed is:

1. A method, comprising:
detecting an alarm condition associated with a network element of a communication network;
generating alarm indication data based on the alarm condition detected;
protecting the alarm indication data using a cryptographic key to generate protected alarm indication data; and
storing the protected alarm indication data in a non-volatile memory.

2. The method of claim 1, wherein the protecting step further comprises integrity protecting the alarm indication data using the cryptographic key to generate integrity protected alarm indication data.

3. The method of claim 1, wherein the protecting step further comprises replay protecting the alarm indication data to generate replay protected alarm indication data.

4. The method of claim 1, wherein the protecting step further comprises confidentiality protecting the alarm indication data to generate confidentiality protected alarm indication data.

5. The method of claim 1, wherein the alarm indication data comprises at least one value indicative of the detected alarm condition.

6. The method of claim 5, wherein the alarm indication data comprises metadata associated with the at least one value indicative of the detected alarm condition.

7. The method of claim 5, wherein the alarm indication data comprises auxiliary data associated with the at least one value indicative of the detected alarm condition.

8. The method of claim 1, wherein the cryptographic key is stored in a tamper-resistant environment of the network element.

9. The method of claim 1, further comprising, upon a subsequent power up cycle of the network element, analyzing the protected alarm indication data stored in the non-volatile memory for a tamper indication.

10. The method of claim 9, further comprising initiating a power off cycle when the analysis indicates that the protected alarm indication data stored in the non-volatile memory has been or likely has been tampered with.

11. The method of claim 9, further comprising placing the network element in a limited functionality mode when the analysis indicates that the protected alarm indication data stored in the non-volatile memory has been or likely has been tampered with.

12. The method of claim 1, further comprising initiating a power off cycle after storing the protected alarm indication data in the non-volatile memory.

13. The method of claim 1, further comprising placing the network element in a limited functionality mode after storing the protected alarm indication data in the non-volatile memory.

14. A computer program product comprising a processor-readable storage medium having encoded therein executable code of one or more software programs, wherein the one or more software programs when executed by at least one processor of the network element implement the steps of the method of claim 1.

15. An apparatus, comprising:
a non-volatile memory; and
at least one processor operatively coupled to the non-volatile memory and configured to:
detect an alarm condition associated with a network element of a communication network;
generate alarm indication data based on the alarm condition detected;
protect the alarm indication data using a cryptographic key to generate protected alarm indication data; and
store the protected alarm indication data in the non-volatile memory.

16. The apparatus of claim 15, wherein the protecting operation further comprises integrity protecting the alarm indication data using the cryptographic key to generate integrity protected alarm indication data.

17. The apparatus of claim 15, wherein the at least one processor is further configured to, upon a subsequent power up cycle of the network element, analyze the protected alarm indication data stored in the non-volatile memory for a tamper indication.

18. The apparatus of claim 17, wherein the at least one processor is further configured to initiate a power off cycle when the analysis indicates that the protected alarm indication data stored in the non-volatile memory has been or likely has been tampered with.

19. The apparatus of claim 17, wherein the at least one processor is further configured to place the network element in a limited functionality mode when the analysis indicates that the protected alarm indication data stored in the non-volatile memory has been or likely has been tampered with.

20. A network element, comprising:
a non-volatile memory; and
at least one processor operatively coupled to the non-volatile memory and configured to:
detect an alarm condition associated with the network element;
generate alarm indication data based on the alarm condition detected;
protect the alarm indication data using a cryptographic key to generate protected alarm indication data; and
store the protected alarm indication data in the non-volatile memory.
